(19) United States
(12) Patent Application Publication
(10) Pub. No.: US 2005/0045837 A1
(43) Pub. Date: Mar. 3, 2005

(54) Method and device for detecting defects, such as stains, scratches and dust, on a film in order, in particular, to correct the said defects while the film is being digitized

(75) Inventor: Patrice Lavergne, Monteynard (FR)

Correspondence Address: HESLIN ROTHENBERG FARLEY & MESITI PC, 5 COLUMBIA CIRCLE, ALBANY, NY, 12203, US

(73) Assignee: KIS, Echirolles (FR)

(21) Appl. No.: 10/888,223

(22) Filed: Jul. 9, 2004

Related U.S. Application Data
(63) Continuation of application No. PCT/FR03/00366, filed on Feb. 5, 2003.

(30) Foreign Application Priority Data
Feb. 5, 2002 (FR) 02/01449

(51) Int. Cl. G01N 21/88

(52) U.S. Cl. 250/559.45

(57) ABSTRACT

A method of detecting defects, such as stains, scratches and dust, on a film in order, for example, to correct said defects while the film is being digitized, comprises advancing the film through an optical assembly comprising: on one side of the film, at least two sources of light having different wavelengths which illuminate the film in a narrow area thereof, and, on the other side of said film, a lens which projects the two images of the area illuminated by the beams from the two sources onto two linear photosensitive elements which are adapted, respectively, to the wavelengths of the two sources. Moreover, said method includes comparing the digital data delivered by the two detection elements, the result of said comparison being used to perform the aforementioned detection and correction.

The present invention relates to a method for detecting defects on a film. It applies in particular, but not exclusively, to the detection of defects such as stains, scratches and dust, on a film in order to correct these defects while the film is being digitized.

In general, it is known that in order to digitize a film by scanning analysis (scanning) the film is usually made to advance through an optical assembly comprising:
on one side, a light source which illuminates the film in a narrow rectangular area, with
on the other side, a lens which projects the image of the illuminated area onto a detection device, in principle a charge coupled device (CCD) detector.

In fact, in the case of digitizing color films, sensors are used comprising three parallel detection lines respectively sensitive to the three fundamental colors (red, green, blue), each of these lines consisting of a succession of CCD cells.

The invention is based on the observation that an infrared image of the film is transparent apart from where there are diffraction spots created by the defects on the surface of the film. These same defects also cause diffraction spots on the RGB images of the three corresponding strips. The comparison of the luminosity level, pixel by pixel, of the four images, infrared and RGB, makes it possible to reconstitute the RGB images without defects by associating a luminosity connection factor with each pixel located where the defect on the film occurs, taking account of the luminosity of nearby pixels without defects.

For the purpose of making such a correction, it has been proposed, in particular by the patent application WO 99 140 729, to use means of filtering the light beam in order to block the visible light (non infrared) which arrives at one of the lines of CCD sensors and to block the infrared light which arrives at a second line of CCD sensors.

This technique has numerous disadvantages. The presence of filters causes an attenuation or dispersion of the light such that the light source must have excess power (it being understood that the defect detection method requires high light intensities if these defects are of very small size).

Furthermore, considering the differences in wavelength between the visible light (RGB) and the infrared used and the different indices of the material traversed by the light radiation, the IR image applied to the CCD strip used for the infrared radiation will not be usable (poor focusing) if the optics are adjusted in such a way as to obtain good focusing on the RGB CCD strips.

The purpose of the invention is therefore to solve these problems and to eliminate these disadvantages.

For this purpose it proposes a method for detecting surface defects, such as stains, scratches and dust, on a film for the purpose of correcting these defects while the film is being digitized. According to the invention this method consists in advancing the film through an optical assembly comprising, on one side of the film, at least two light sources having different wavelengths which illuminate the film in a narrow area thereof, and, on the other side of the film, a lens which projects two images of the area illuminated by the beams coming from the two sources onto two linear photosensitive elements which are adapted, respectively, to the wavelengths of the two sources, and in comparing the digital data delivered by the two detection elements, the result of this comparison being used to perform the aforementioned detection and correction.

Due to these arrangements, it becomes possible to obtain simultaneously a focusing of the RGB images onto the RGB detectors and of the infrared image onto the infrared detector without having to move the detector.

Moreover, the light dispersion and attenuation problems are considerably reduced such that it is possible to considerably reduce the dimensions of the light sources and of all their accessories (cooling., power supply, etc.).

Furthermore, the result obtained is independent of the optics used in particular for producing the lens used between the film and the CCD strips. In particular, the problems of longitudinal aberration of this lens are overcome in this way.

It will be possible to use a third and separate light source for the RGB CCD strips to read the bar codes present on the film.

Embodiments of the invention will be described below, by way of non-limiting example, with reference to the appended drawings in which:

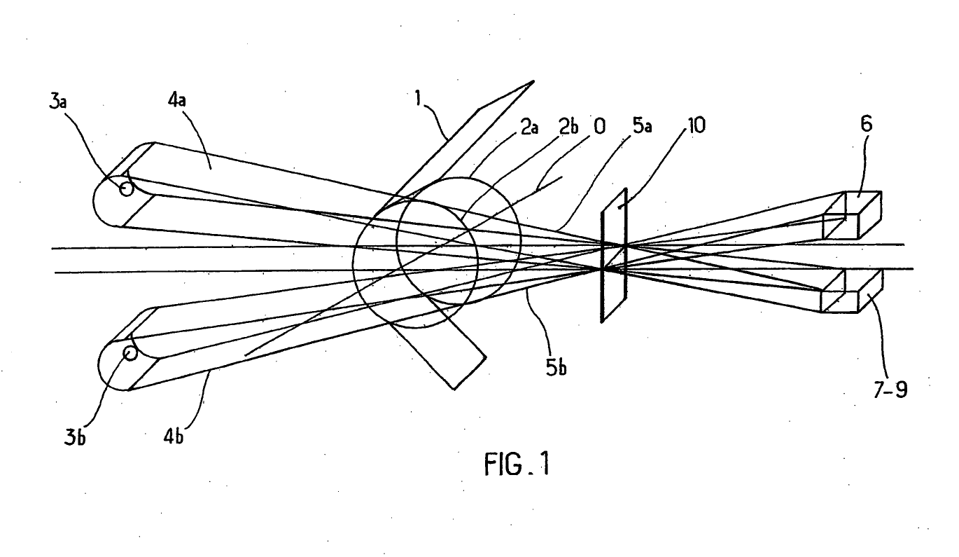

FIG. 1 is a diagrammatic representation of a device using an RGB light source and an infrared light source;

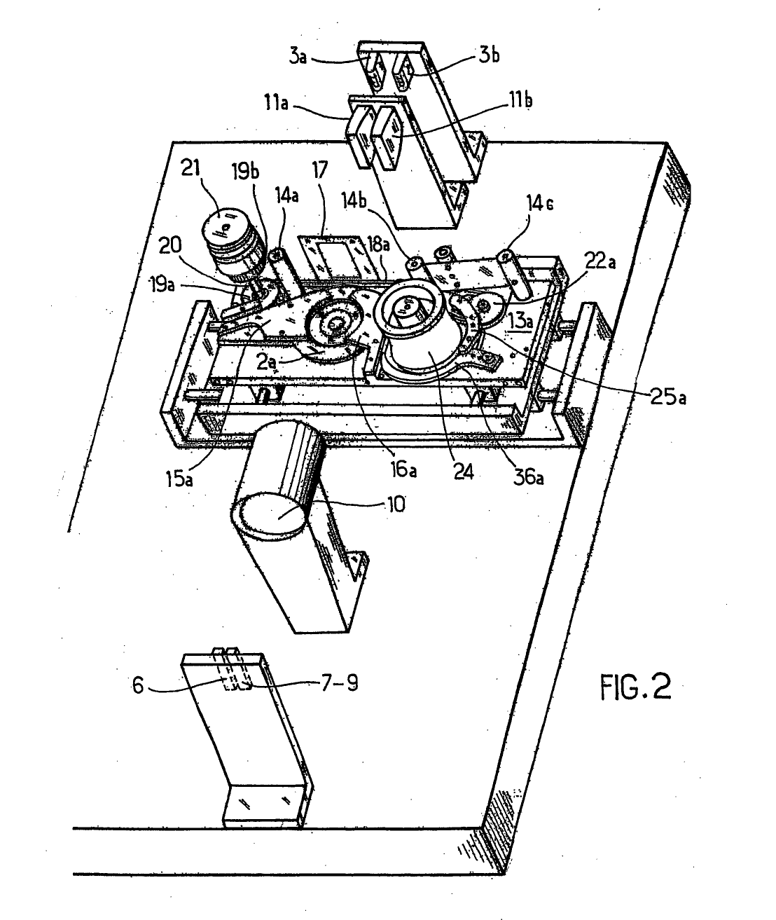

FIG. 2 is a partial perspective view of one embodiment of the device according to the invention;

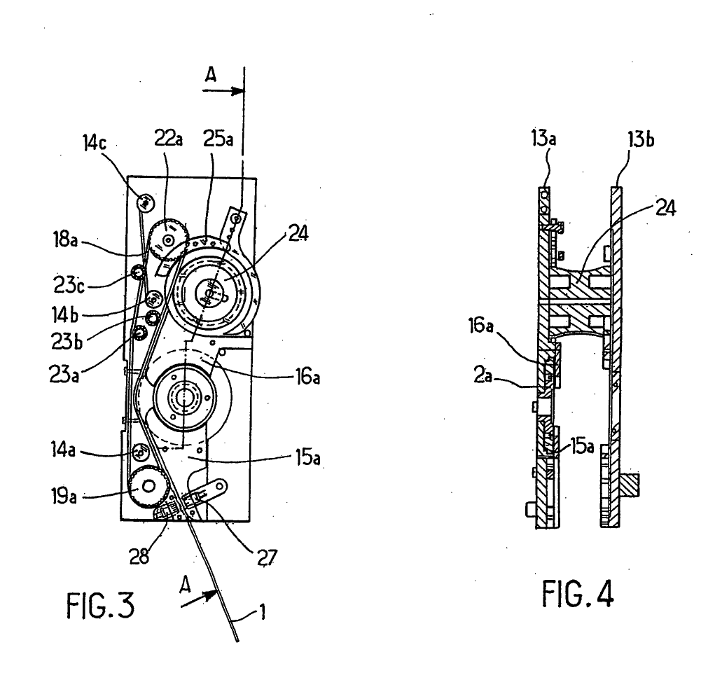

FIG. 3 is a diagrammatic partial elevation of one embodiment of the device according to the invention;

FIG. 4 is a diagrammatic partial cross-section, through AA, of one embodiment of the device according to the invention.

In this example, the film 1 is carried by two rollers 2a, 2b disposed in such a way that the film 1 is guided at the level of its two lateral edges and that the space situated between the two rollers 2a, 2b is greater than or at least equal to the useful area of the film 1.

The film 1 follows, at the level of the rollers 2a, 2b, a circular path whose generatrices are parallel with the axis O of the rollers 2a, 2b.

The film 1 is illuminated by two light sources 3a, 3b:
the source 3a generates a beam of white light 4a,
the source 3b generates a beam of infrared light 4b.

The two incident beams 4a and 4b are characterized by a rectangular shaped cross-section in a transverse plane with respect to the direction of propagation. The length of the rectangular section is parallel with the generatrices of the circular path of the film 1 at the level of the rollers 2a, 2b, and this length is at least equal to the useful area of the film 1. The width of the rectangular section of the two beams 4a, 4b is defined by the resolution of the scanning analysis of the film 1.

The two incident beams 4a, 4b generate, after passing through the film 1, two transmitted light beams 5a, 5b containing the useful information respectively in white light, referred to as RGB, and infrared light, referred to as IF, intended for scanning analysis.

The two transmitted beams 5a, 5b are then focused onto CCD strips 6 and 7-9 respectively, by means of a lens 10.

FIG. 2 illustrates various elements of the device fixed on a support, namely:
a support comprising the two separate light sources 3a, 3b, side by side,
a support for two light guides/shapers 11a, 11b, each one being positioned in front of one of the light sources,
a device for guiding the film,
a lens 10 for the beams 4a, 4b respectively coming from the sources 3a, 3b,
a support comprising the infrared 6 and RGB 7-9 CCD strips.

The supports of the sources, guides and CCD strips and the lens are all aligned along a common axis.

The device for guiding the film is interposed between the guides and the lens.

The structure of the device for guiding the film comprises two parallel metal plates, only one of which is shown 13a, separated by three cross-pieces 14a, 14b, 14c disposed along the upper side of the plates. These different elements constitute a rigid constituent assembly of the device for guiding the film 1. The distance separating the two metal plates 13a, 13b is slightly greater than the width of the film 1 to be analyzed.

The device for guiding the film 1 comprises in a focusing area two parallel coaxial rollers, only one of which is shown 2a, mounted such that they rotate on ball bearings and held by backing plates, of which one pair of backing plates is shown 15a, 16a. The lateral edges of the film 1 respectively come to bear on the two rollers 2a and 2b, along an arc of circle in such a way that the film follows a circular trajectory. Thus, along this circular trajectory, it has a cylindrical shape with a straight generatrix. This position makes it possible to obtain in the focusing area a straight transverse area perpendicular to which is disposed a slot formed in a plate 17 integral with the two plates 13a and 13b forming a rectangular space for conveying the beams 4a, 4b transmitted by the light sources 3a, 3b/light guides 11a, 11b assemblies situated facing the outside side of the plate 17.

The device for driving the film 1 comprises two parallel belts, only one of which is shown 18a, which move in a synchronous manner and which respectively come to bear on the lateral edges of the film 1 at the level of its circular trajectory over the rollers 2a and 2b. In this way a friction drive of the two lateral edges of the film 1 is obtained, which eliminates any possibility of variation of speed between these two edges. The two belts 18a, 18b have notches on the side facing away from the film 1, the driving of the belts being carried out by means of two coaxial notched pulleys 19a and 19b whose common shaft 20 is driven by an electric motor 21 and two free notched pulleys, of which only one is shown 22a. The tension and the positioning of the two belts 18a,18b are provided by rollers, of which only one set is shown 23a, 23b, 23c.

The device for winding the film 1 consists of a diabolo-shaped roller 24 mounted such that it rotates about a shaft 25 parallel with the axis of the rollers with spring return. This shaft is guided in such a way as to be able to move along an oblong opening according to the thickness of the winding of the film 1 on the roller 24. The major axis of the oblong opening is oriented perpendicular to the tangential plane of application of the belts on the edges of the film (force of application collinear with the major axis of the oblong hole). Two pairs of arms, only one pair of which is shown 25a and 26a, guide the film, when it is introduced or when it is extracted, around the diabolo-shaped roller 24. The arms 25a and 25b are articulated. It is observed that the angular velocity of the diabolo, the latter not having its own drive means, depends on the amount of winding of the film 1.

The zone of introduction of the film 1 comprises a light source 27/detector 28 assembly located on both sides of the film and intended for reading bar codes situated on the border of the film in such a way, on the one hand, to be able to identify the film and, on the other hand, to check that it has been inserted in that place.

It should be noted that the infrared and white sources do not illuminate the same area of the film at the same time; it is therefore necessary to note the distance between the two illumination areas and to save the data in order to process it.

1. A method for detection and correction of surface defects on a film, comprising advancing the film through an optical assembly comprising, on one side of the film, at least two light sources having different wavelengths which illuminate the film in a narrow area thereof, and, on another side of the film, a lens which projects two images of the area illuminated by beams coming from the two sources onto two linear photosensitive elements which are adapted, respectively, to the wavelengths of the two sources, and comparing digital data delivered by the two photosensitive elements, a result of this comparison being used to perform the aforementioned detection and correction.

2. The method as claimed in claim 1, wherein one of the sources emits a beam of white light, whilst an other source emits a beam of infrared light.

3. The method as claimed in claim 1, wherein said photosensitive elements comprise, respectively, CCD detector strips.

4. The method as claimed in claim 2, wherein said beam of white light is applied to three CCD detector strips respectively sensitive to three fundamental colors, red, green and blue, whilst said beam of infrared light is applied to a CCD detector strip sensitive to infrared.

5. The method as claimed in claim 1, wherein projection of said illuminated area of the film is carried out by focusing using the lens that is common to both beams.

6. The method as claimed in claim 1, wherein said beams have a rectangular shaped cross-section in a transverse plane with respect to a direction of propagation.

7. The method as claimed in claim 1, wherein said beams have a cross-sectional width defined by resolution of a scanning analysis of the film.

8. The method as claimed in claim 1, further comprising a light source detector assembly for reading bar codes situated on the film.

9. The method as claimed in claim 8, wherein said assembly is situated in an area of introduction of the film.
